(19) United States
(12) Patent Application Publication
(10) Pub. No.: US 2016/0052524 A1
(43) Pub. Date: Feb. 25, 2016

(54) SYSTEM AND METHOD FOR ALERTING DROWSY DRIVING

(71) Applicant: Hyundai Motor Company, Seoul (KR)

(72) Inventors: Jin Kwon Kim, Suwon (KR); Sam Yong Kim, Hwaseong (KR); Ho Choul Jung, Suwon (KR); Byoung Joon Lee, Suwon (KR)

(21) Appl. No.: 14/569,656

(22) Filed: Dec. 13, 2014

(30) Foreign Application Priority Data
Aug. 25, 2014 (KR) 10-2014-0110950

(51) Int. Cl. B60W 40/09; G06K 9/00; G08B 21/06

(52) U.S. Cl. CPC B60W 40/09; G08B 21/06; G06K 9/00845; B60W 2540/22

(57) ABSTRACT

A system and method for alerting drowsy driving are provided. The system includes a d controller configured to analyze a driving pattern of a vehicle to detect a dangerous driving pattern. In addition, the controller is configured to analyze a face image of a driver to detect an eye pattern maintained for a predetermined period of time or longer. Further, the controller is configured to determine that the driver is driving while drowsy when the eye closing for the predetermined period of time or longer and the dangerous driving pattern are simultaneously detected.

### CROSS-REFERENCE TO RELATED APPLICATION

This application is based on and claims the benefit of priority to Korean Patent Application No. 10-2014-0110950, field on Aug. 25, 2014, the disclosure of which is incorporated herein in its entirety by reference.

### TECHNICAL FIELD

The present disclosure relates to a system and method for alerting a drowsy driving, and more particularly, to a system and method for determining drowsy driving state by combining and analyzing a driver face image and driving pattern information.

### BACKGROUND

Drowsy driving is a hindrance against safe driving since a driver may not be fully aware of other drivers around him. Whether the drowsy driving may be prevented may depend on a driver. However, when a vehicle is operated by a drowsy driver an accident may occur before the driver is aware of the drowsy state. According to a related art, the drowsy driving is determined by photographing the closing of the driver's eyes, the lowering of a head, or the like. However, since a system for alerting drowsy driving according to the related art has been configured to perform the alarm only when a fatigue pattern is accumulated and when such a pattern is maintained for a predetermined time or longer and does not perform the alarm at a substantially drowsy time, the effectiveness thereof may be decreased.

### SUMMARY

An aspect of the present disclosure provides a system and method for alerting drowsy driving that may be configured to enable safe driving by the driver by combining a state of the driver and driving pattern information to more accurately determine drowsy (e.g., unsafe) driving state and alerting the driver.

According to an exemplary embodiment of the present disclosure, a system for alerting drowsy driving may include: a driving pattern analyzer configured to analyze a driving pattern of a vehicle and detect a dangerous driving pattern; a driver's face image analyzer configured to analyze a face image of a driver and detect in the face image an eye pattern maintained for a predetermined period of time or longer; and a drowsy drive determinator configured to determine when the driver is currently driving while drowsy when the eye closing for the predetermined period of time or longer and the dangerous driving pattern are detected simultaneously. The system may further include: an alarm configured to output at least one selected from the group consisting of: an alarm sound, an alarm phrase, and an alarm vibration; and a controller configured to execute the output of the alarm when the drowsy drive determinator determines the driver is driving while drowsy.

The dangerous driving pattern may include at least one selected from the group consisting of: a zigzag pattern, an over-steering pattern, an under-steering pattern, a lane violation pattern, and a lane following error pattern. The driver face image analyzer may be configured to detect an eye open or close state of the driver to detect the eye closing for the predetermined period of time or longer. Further, the driver face image analyzer may be configured to detect a half-closed eye of the driver within an eye closing pattern. The drowsy drive determinator may be configured to determine that the driver may be driving while drowsy when the eye closing for the predetermined period of time or longer and an under-steering pattern are simultaneously detected. Further, the drowsy drive determinator may be configured to determine the driver may be driving while drowsy when an over-steering pattern is detected after the driver's eyes open after the eye closing for the predetermined period of time or longer. In addition, the drowsy drive determinator may be configured to determine that the driver may be driving while drowsy when a substantially high transverse velocity is maintained while the eye closing for the predetermined period of time or longer is detected.

According to the present disclosure, a method for alerting a drowsy drive may include: simultaneously analyzing, by a controller, a driving pattern and an eye closing pattern for a predetermined period of time or longer; and determining, by the controller, whether a driver is driving while drowsy when a dangerous driving pattern and the eye closing pattern for the predetermined period of time or longer are detected. The method may further include outputting, by the controller, at least one selected from the group consisting of: an alarm phrase, an alarm sound, and an alarm vibration as a drowsy drive alarm in response to determining that the driver is driving while drowsy.

The determination of whether the driver is driving while drowsy, may include determining, by the controller, the driver may be driving while drowsy when the eye closing for the predetermined period of time or longer and an under-steering pattern are simultaneously detected. Further, the determination of whether the driver may be driving while drowsy may include determining, by the controller, the driver is driving while drowsy when an over-steering pattern is detected after the driver's eyes open after the eye closing for the predetermined period time or longer. In addition, the determination of whether the driver may be driving while drowsy may include determining, by the controller, the driver is driving while drowsy when a substantially high transverse velocity is maintained while the eye closing for the predetermined period of time or longer is detected.

### BRIEF DESCRIPTION OF THE DRAWINGS

The above and other objects, features and advantages of the present disclosure will be more apparent from the following detailed description taken in conjunction with the accompanying drawings.

FIG. 1 is an exemplary configuration diagram of a system for alerting a drowsy drive according to an exemplary embodiment of the present disclosure;

FIG. 2 is an exemplary diagram illustrating a method for alerting a drowsy drive according to an exemplary embodiment of the present disclosure;

FIG. 3A is an exemplary diagram describing a condition for detecting the drowsy drive according to a first exemplary embodiment of the present disclosure;

FIG. 3B is an exemplary graph describing a method for detecting the drowsy drive according to a first exemplary embodiment of the present disclosure;

FIG. 4A is an exemplary diagram describing a condition for detecting the drowsy drive according to a second exemplary embodiment of the present disclosure;

FIG. 4B is an exemplary graph describing a method for detecting the drowsy drive according to a second exemplary embodiment of the present disclosure;

FIG. 5A is an exemplary diagram describing a condition for detecting the drowsy drive according to a third exemplary embodiment of the present disclosure; and

FIG. 5B is an exemplary graph describing a method for detecting the drowsy drive according to a third exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, exemplary embodiments of the present disclosure will be described in detail with reference to the accompanying drawings so that those skilled in the art may easily implement the spirit of the present disclosure.

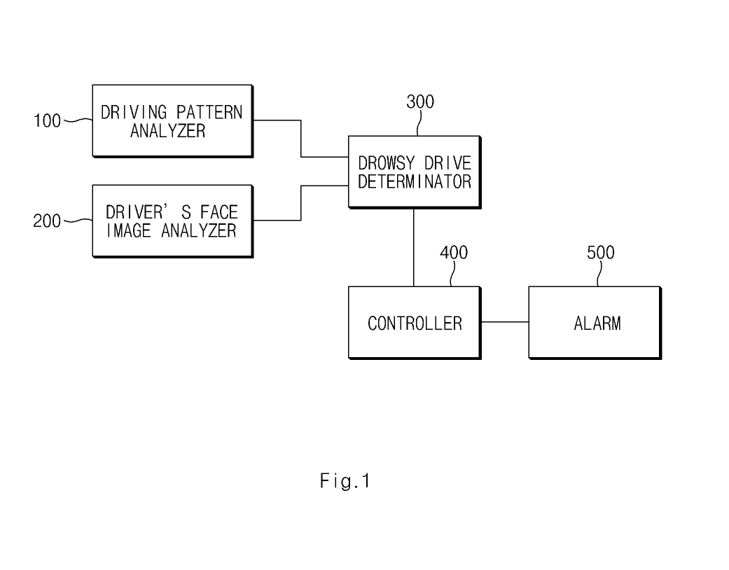

The present disclosure relates to a system and method capable of more accurately determining drowsy driving by a driver that simultaneously considers driver state information and driving pattern information. Hereinafter, exemplary embodiments of the present disclosure will be described in detail with reference to FIGS. 1 to 5B. FIG. 1 is an exemplary configuration diagram of a system for alerting drowsy driving according to an exemplary embodiment of the present disclosure. The system for alerting the drowsy drive according to the exemplary embodiment of the present disclosure may include a driving pattern analyzer 100, a driver's face image analyzer 200, a drowsy drive determinator 300, a controller 400, and an alarm 500. The controller 400 may be configured to operate the driving pattern analyzer, the driver's face image analyzer 200, the drowsy drive determinator 300, and the alarm 500.

The driving pattern analyzer 100 may be configured to analyze a driving state of a vehicle and determine whether the driving state of the vehicle is a dangerous driving pattern state (e.g., a state in which accident risk may be increased). Accordingly, the dangerous driving pattern may include a zigzag pattern (e.g., drifting back and forth), an over-steering pattern (e.g., overturning a steering wheel), an under-steering pattern (e.g., undertuming a steering wheel), a lane violation pattern (e.g., crossing a driving lane line), a lane following error pattern (e.g., not following a driving lane line), and the like. In particular, although not shown, the driving pattern analyzer 100 may be configured to collect steering information, transmission information, lane information, and the like of the vehicle using a steering angle sensor (not shown), a transmission (not shown), a radar (not shown), and the like.

The driver's face image analyzer 200 may be configured to analyze an open or close of driver eyes using image data obtained by imaging a front (eyes) of the driver using an imaging device (e.g., a camera, a video camera, etc.) (not shown), or the like and whether the driver's eyes of the driver are closed for a predetermined period of time or longer from a face image. For example, when the driver's eyes are closed for about 0.5 seconds or longer, it may be determined as a substantially long eye closing. Further, when the eyes are half-closed may also be determined as the closed state. The drowsy drive determinator 300 may be configured to determine whether the driver is driving while drowsy by combining both analyzed results of the driving pattern analyzer 100 and the driver face image analyzer 200.

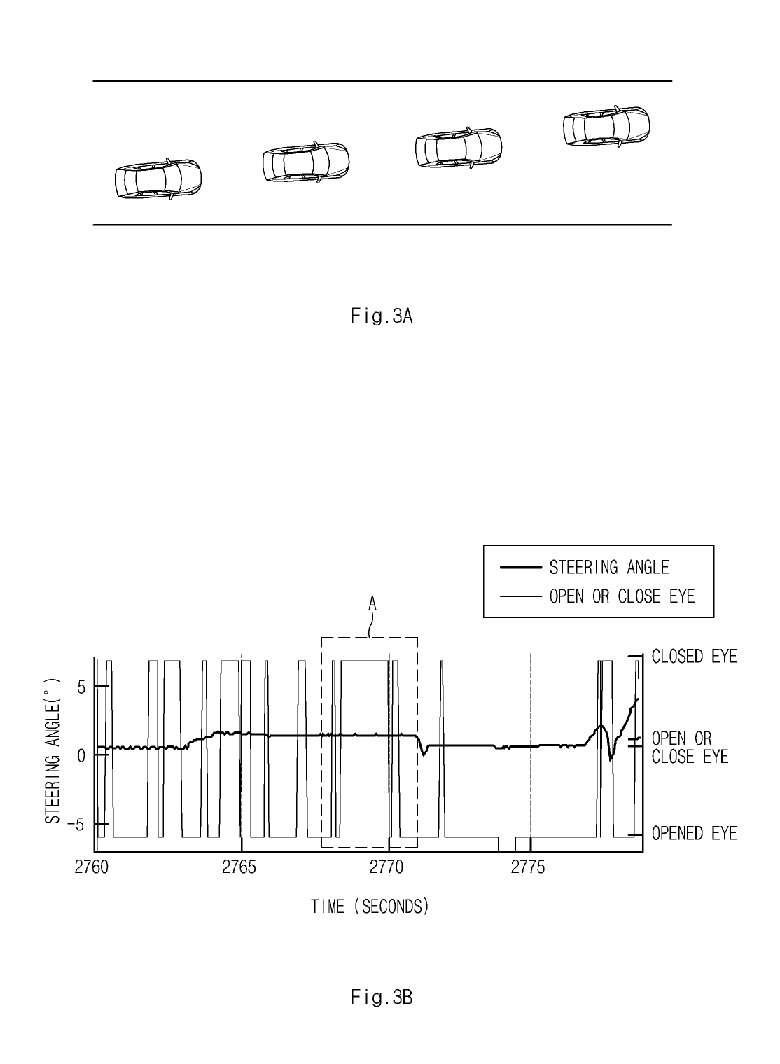

Conditions for determining whether the driver is driving while drowsy may be represented by the following three conditions. First, the drowsy drive determinator 300 may be configured determine the driver is in a drowsy drive state when the substantially long eye closing pattern (e.g., when the eyes are closed for about 0.5 seconds or longer) and an under-steering pattern, as shown in FIG. 3A, are detected simultaneously. Referring to FIG. 3B, it may be appreciated that when a steering angle or a steering torque is maintained (e.g., for about 2 seconds or longer) and simultaneously occurs with the substantially long eye closing pattern, time period A may emerge. Based on the above, the drowsy drive determinator 300 may be configured to determine the driver is driving while drowsy within time period A of FIG. 3B.

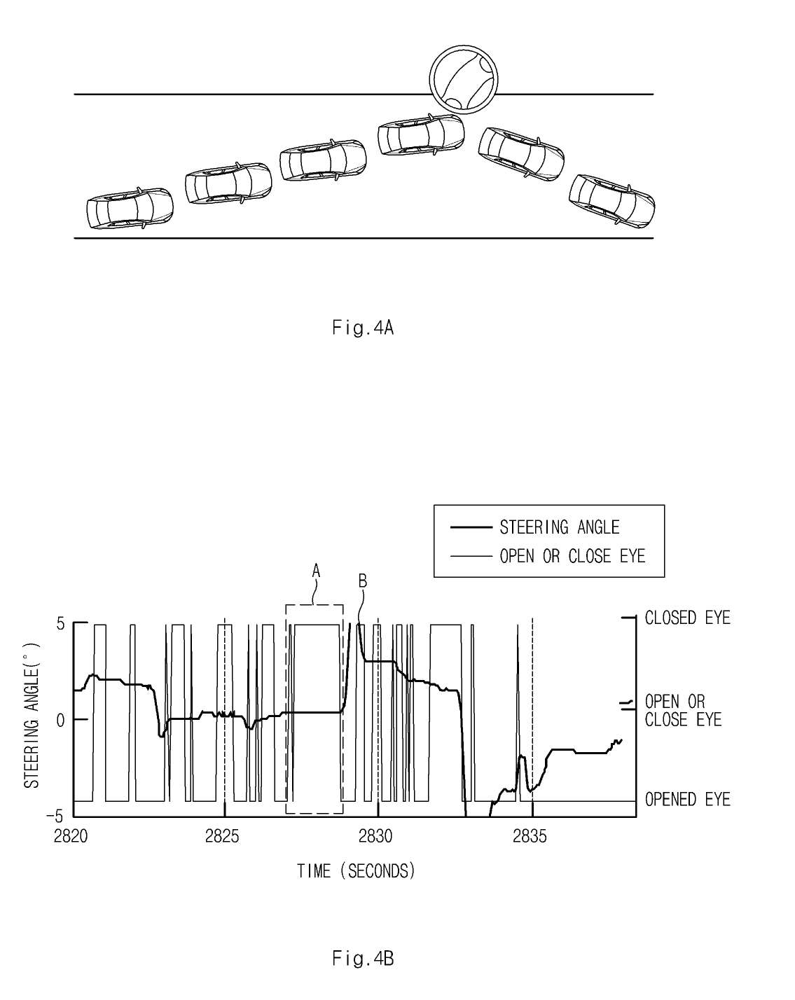

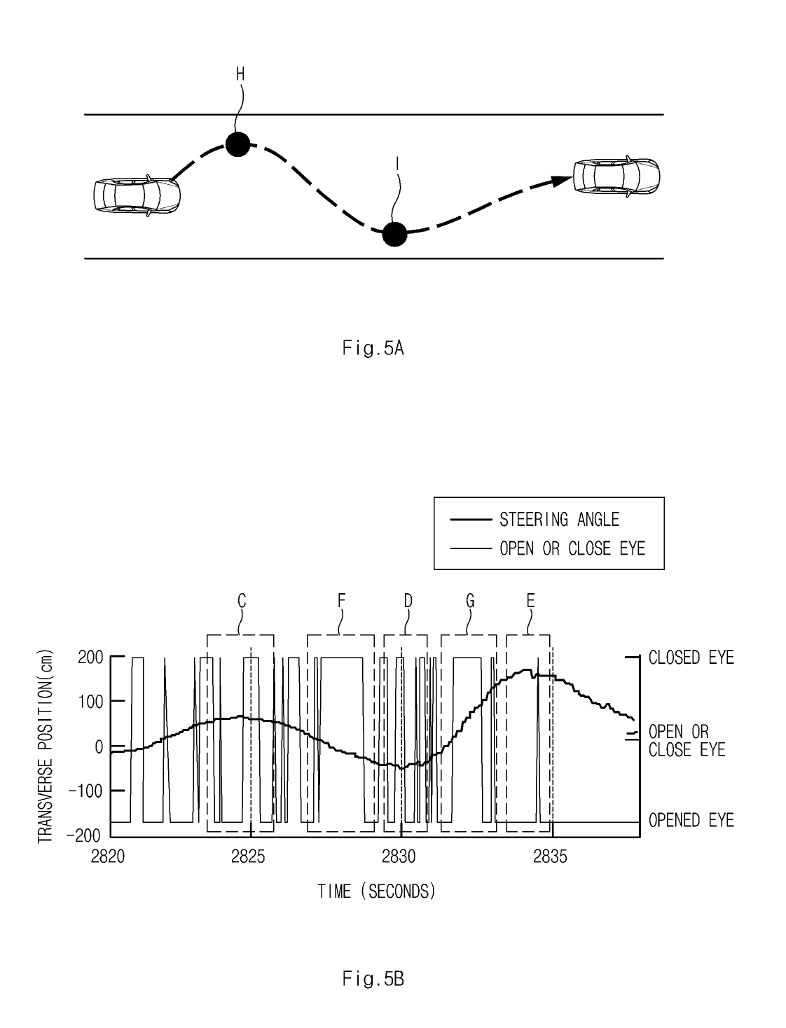

Second, the drowsy drive determinator 300 may be configured to determine that the driver is in the drowsy drive state when an over-steering pattern is detected and the driver's eyes open (e.g., time period B of FIG. 4B) after the substantially long eye closing pattern (e.g., time period A of FIG. 4B) as shown in FIG. 4B. In other words, referring to FIG. 4A, the drowsy drive determinator 300 may be configured to determine the over-steering pattern when the steering angle or the steering torque suddenly changes (e.g., about 5° or greater) while driving in an under-driving pattern. The over-steering pattern may occur after the under-steering pattern and both a first condition and a second condition are satisfied, and may be determined as drowsy driving. Third, the drowsy driving sensor 300 may be configured to determine the driver is in the drowsy drive state when the vehicle is not driven within the driving lane lines, as shown in FIG. 5A, and the substantially long eye closing pattern is detected simultaneously.

Referring to FIG. 5B, when an eye closing is at pole occurrence positions (e.g., time periods C, D, E), the controller may be configured to determine that the driver is not in the drowsy driving state (e.g., accident risk is not present). However, when a substantially high transverse velocity and the substantially long eye closing are detected, the controller may be configured to determine that the driver is in the drowsy driving state. In other words, the drowsy drive determinator 300 may be configured to determine the driver is in the drowsy drive state when the substantially long eye closing pattern occurs between two poles (e.g., time H, I of FIG. 5A) of transverse positions within a lane and whether the under-steering pattern and the substantially long eye closing pattern are detected simultaneously between the two poles (e.g., times H, I). When at least one of the above-mentioned three conditions is satisfied, drowsy driving may be determined. Further, to increase an accuracy of the determination of drowsy driving, drowsy driving may be determined when all three conditions are satisfied.

The controller 400 may be configured to transmit an alarm output request signal to the alarm 500 when the drowsy drive determinator 300 determines the driver is currently driving while drowsy. The alarm 500 may be configured to output an alarm. The alarm may include an alarm phrase, an alarm sound, an alarm vibration, and the like. According, the system for alerting the drowsy drive may include a display (not shown) configured to display the alarm phrase, a speaker (not shown) configured to output the alarm sound, a haptic sheet (not shown) configured to output the alarm vibration, and the like.

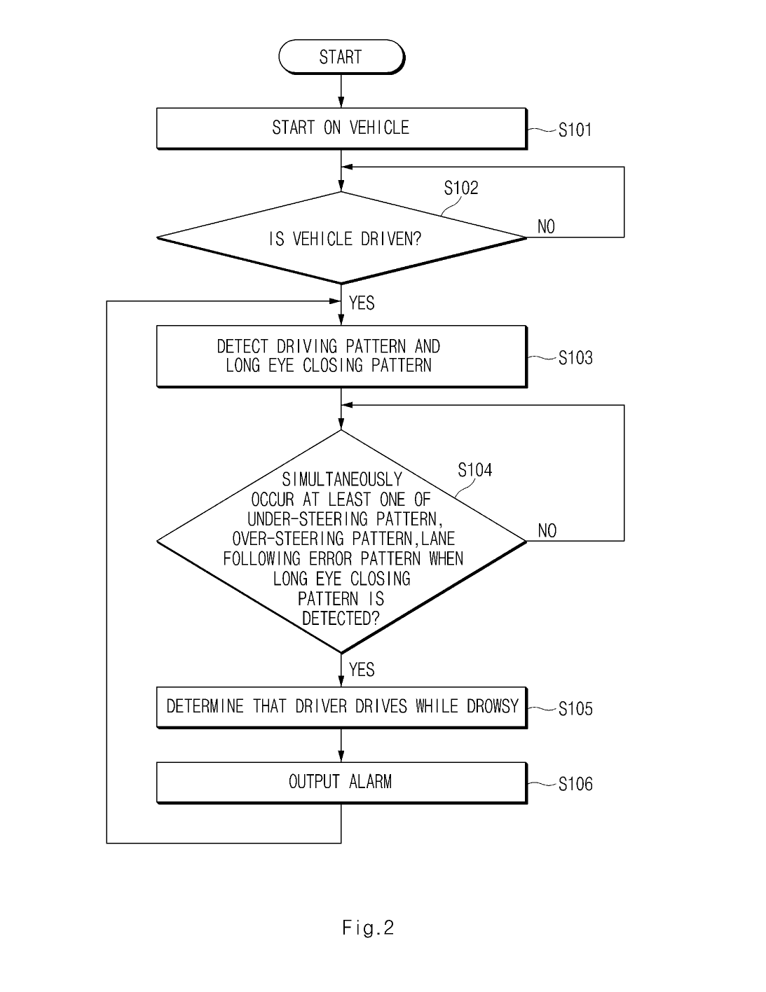

Hereinafter, a method for alerting a drowsy drive according to an exemplary embodiment of the present disclosure will be described in detail with reference to FIG. 2. First, a vehicle turns on (S101), and when the vehicle is driven (S102), the method may include simultaneously analyzing, by a controller, the driving pattern and an eye closing pattern for a predetermined time or longer (S103). Further, the method may include determining, by the controller, whether a driver is driving while drowsy when a dangerous driving pattern and the eye closing pattern for the predetermined period of time or longer is detected (S104). In other words, whether the driver is driving while drowsy may be determined by determining, by a controller, whether at least one of the under-steering pattern, the over-steering pattern, and the lane following error pattern, which may be the dangerous driving patterns, has occurred simultaneously with the substantially long eye closing pattern.

When the substantially long eye closing pattern and the dangerous driving patterns are detected simultaneously, the method may include determining, by the controller that the driver is driving while drowsy (S105) and outputting an alarm 500 (S106). Accordingly, the present disclosure may determine that the driver is in the drowsy drive state when a dangerous driving pattern and the substantially long eye closing pattern are detected simultaneously. Thus, whether the driver is driving while drowsy may be determined simultaneously using the driving patterns of the vehicle and the eye closing pattern, such that an accuracy of determining whether the driver is driving while drowsy may increase. As described above, the present technology may increase driver safety by more accurately determining the drowsy drive and alerting the driver. The exemplary embodiments of the present disclosure described above have been provided for illustrative purposes. Therefore, those skilled in the art will appreciate that various modifications, alterations, substitutions, and additions are possible without departing from the scope and spirit of the disclosure as disclosed in the accompanying claims and such modifications, alterations, substitutions, and additions fall within the scope of the present disclosure.

What is claimed is:

1. A system for alerting a drowsy drive, comprising:
a memory configured to store program instructions; and
a controller configured to execute the program instructions, the program instructions when executed configured to:
analyze a driving pattern of a vehicle;
detect a dangerous driving pattern;
analyze a face image of a driver;
detect in the face image an eye pattern for a predetermined period of time or longer; and
determine the driver is driving while drowsy when the eye closing for the predetermined period of time or longer and the dangerous driving pattern are simultaneously detected.

2. The system according to claim 1, wherein the program instructions when executed are further configured to output at least one of selected from the group consisting of: an alarm sound, an alarm phrase, and an alarm vibration.

3. The system according to claim 1, wherein the dangerous driving pattern includes at least one selected from the group consisting of a zigzag pattern, an over-steering pattern, an under-steering pattern, a lane violation pattern, and a lane following error pattern.

4. The system according to claim 1, wherein the program instructions when executed are further configured to
detect an eye open or close of the driver to detect the eye closing for the predetermined period of time or longer,
wherein the eye close includes a half-closed eye of the driver.

5. The system according to claim 1, wherein the program instructions when executed are further configured to:
determine that the driver is driving while drowsy when the eye closing for the predetermined period of time or longer and an under-steering pattern are detected simultaneously.

6. The system according to claim 1, wherein the program instructions when executed are further configured to:
determine the driver is driving while drowsy when an over-steering pattern is detected after the driver's eyes open after the eye closing for the predetermined period time or longer.

7. The system according to claim 1, wherein the program instructions when executed are further configured to:
determine the driver is driving while drowsy when a substantially high transverse velocity is maintained while the eye closing for the predetermined period of time or longer is detected.

8. A method for alerting a drowsy drive, the method comprising:
simultaneously analyzing, by a controller, a driving pattern and an eye closing pattern, from a face image, for a predetermined period of time or longer; and
determining, by the controller, whether a driver is driving while drowsy when a dangerous driving pattern and the eye closing pattern for the predetermined period of time or longer is detected.

9. The method according to claim 8, further comprising outputting, by the controller, at least one selected from the group consisting of: an alarm phrase, an alarm sound, and an alarm vibration as a drowsy drive alarm when it is determined that the driver is driving while drowsy.

10. The method according to claim 9, wherein the determining of whether the driver is driving while drowsy includes:
determining, by the controller, the driver is driving while drowsy when the eye closing for the predetermined period of time or longer and an under-steering pattern are detected simultaneously.

11. The method according to claim 9, wherein the determining of whether the driver is driving while drowsy includes:
determining, by the controller, the driver is driving while drowsy when over-steering pattern is detected after the driver's eyes open after the eye closing for the predetermined period time or longer from a face image.

12. The method according to claim 9, wherein the determining of whether the driver is driving while drowsy includes:
determining, by the controller, the driver is driving while drowsy when a substantially high transverse velocity is maintained while the eye closing for the predetermined period of time or longer is detected.

13. A non-transitory computer readable medium containing program instructions executed by a controller, the computer readable comprising:
program instructions that analyze a driving pattern of a vehicle;
program instructions that detect a dangerous driving pattern;
program instructions that analyze a face image of a driver;
program instructions that detect in the face image an eye pattern maintained for a predetermined period of time or longer; and
program instructions that determine the driver is driving while drowsy when the eye closing for the predetermined period of time or longer and the dangerous driving pattern are simultaneously detected

14. The non-transitory computer readable medium of claim 13, further comprising program instructions that output at least one of selected from the group consisting of: an alarm sound, an alarm phrase, and an alarm vibration.

15. The non-transitory computer readable medium of claim 13, wherein the dangerous driving pattern includes at least one selected from the group consisting of a zigzag pattern, an over-steering pattern, an under-steering pattern, a lane violation pattern, and a lane following error pattern.

16. The non-transitory computer readable medium of claim 13, the program instructions further comprising:
program instructions that detect an eye open or close of the driver to detect the eye closing for the predetermined period of time or longer,
wherein the eye close includes a half-closed eye of the driver.

17. The non-transitory computer readable medium of claim 13, the program instructions further comprising:
program instructions that determine that the driver is driving while drowsy when the eye closing for the predetermined period of time or longer and an under-steering pattern are detected simultaneously.

18. The non-transitory computer readable medium of claim 13, the program instructions further comprising:
program instructions that determine the driver is driving while drowsy when an over-steering pattern is detected after the driver's eyes open after the eye closing for the predetermined period time or longer.

19. The non-transitory computer readable medium of claim 13, the program instructions further comprising:
program instructions that determine the driver is driving while drowsy when a substantially high transverse velocity is maintained while the eye closing for the predetermined period of time or longer is detected.
